(19) United States
(12) Patent Application Publication
(10) Pub. No.: US 2003/0193928 A1
(43) Pub. Date: Oct. 16, 2003

(54) Universal Network and Internet Point-Of-Presence (UNIPOP)

(76) Inventors: Howard Clay Whetzel JR., Lumberton, NC (US); John Wesley Spence JR., Washington, NC (US)

Correspondence Address: John W. Spence, Jr., 300 Commerce Ave., Lumberton, NC, 28358, US

(21) Appl. No.: 10/119,825

(22) Filed: Apr. 11, 2002

(51) Int. Cl. H04L 12/66

(52) U.S. Cl. 370/352; 370/356

(57) ABSTRACT

A method and system for assigning multiple wired and/or wireless internet communication channels in a local loop system that utilizes unique network, multi-protocol routing, and multiple forms of internet access and distribution. The system is designed to support POTS (Plain Old Telephone), ISDN, T-1, DS-3, and spread and direct spectrum wireless transmission and reception. The system is inherently flexible so as to provide Enhanced Bandwidth and quality of service (QOS). The system further utilizes scaleable architecture for bandwidth expansion and higher data rate services. It also utilizes optional grounding schemes for lightning and high-potential static energy abatement.

### CROSS-REFERENCE TO RELATED APPLICATIONS

N/A

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISK APPENDIX

N/A

### BACKGROUND OF THE INVENTION

The local loop of a telephone system is what some have termed the “last mile” or the “last 1000 feet”. This local loop is essentially the copper wire that connects the customer's house or business to the telecommunications network. The cost of burying and installing the copper wire can be very expensive, time-consuming, and time-sensitive. The latest US Census Bureau statistics indicate that over 60% of the United States lives in rural areas so creating such an infrastructure can be prohibitively expensive.

Many rural communities are turning to wireless or a combination of wired/wireless solutions for their telecommunication needs. However, conventional wired/wireless telecommunication technologies suffer from a number of disadvantages. Due to the poor quality of the service, connections are frequently difficult to establish and maintain. Even where modem connections are possible, data rates are often prohibitively slow.

Conventional wireless telecommunication technologies are inefficient in their use of RF spectrum resources. These deficiencies are particularly troublesome in view of the fact that internet usage is burstable in nature. Analysis of internet data usage indicates that approximately 95-97% of the time, the data network is idle. Furthermore, the aggregate throughput to a user is typically less than 5 kilobits per second.

Therefore, there is a need for a wired/wireless telecommunication system to replace the fragmented wired or wireless systems in place today which more efficiently allocates resources between internet supply sources yet maintains a desirable high quality-of-service and connection rate.

### BRIEF SUMMARY OF THE INVENTION

It is an object of the invention to provide a wired and wireless telecommunication system that allows individual subscribers in an area of service internet and data access via POTS (plain old telephone system which is limited), ISDN (Integrated Services Digital Network with channels only limited by the supply bandwidth), T-1, DS-3, or spread or direct spectrum wireless access point(s). This system facilitates full data and internet utilization in the unique combination of wired and/or wireless access in a single point-of-presence. This system is designed to provide infrastructure for those communities with limited or no local access in place.

These and other objects are achieved by a wired internet loop (WIL) comprising a first interface connecting the WIL to the telecommunications network and internet, a second interface connecting the WIL to a plurality of customer premise equipment (CPE) such as computers, switches, network gear, and a third wireless interface point (WIP) connected to multi-point radio frequency (RF) communications channels connecting the first interface to the wireless subscribers. The ISDN and multi-point RF communication channels provide the user with Transmission Control Protocol and Internet Protocol (TCP/IP) data.

It is a further object of the present invention to provide concentrated access to the telecommunications network to areas of service that are expected to have high telecommunications traffic demand and existing limited telecommunications infrastructure. The UNIPOP provides the high traffic demand structure with flexible and scalable capability. All wireless communication channels provide an acceptable grade of service (GOS) and all dedicated wired channels have QOS capability.

It is a further object of the present invention to provide for dynamic aggregation of the various channels in the WIL. As the usage conditions of the WIL change, the channels can be dynamically changed and or combined to meet the differing conditions. Such dynamic aggregation can be used upon initial system setup to get all subscriber units on the system operational as quickly as possible. Dynamic aggregation can also be used to improve overall system performance during adverse weather conditions (wireless degradation) so as to increase the efficiency and output of the system.

It is a further object of the present invention to provide the subscriber with a fast and efficient internet interface—either wired or wireless. This and other objects of the present invention are achieved by a capability referred to as “universal internet access.” The present invention advantageously uses subscriber usage statistics (internet usage is idle approximately 97% of the time) to allow a large group of subscribers universal shared access to an internet point-of-presence. The system performs at a grade of service typical of other spread or direct spectrum wireless interfaces.

Through the use of an interface at the subscriber premises, a internet access protocol can be utilized to provide the subscriber with a fast and efficient wired or wireless data interface. Such an interface could use consumer-type modems or wireless interface points to achieve such communications. The WIL's would eliminate the requirement that each user be assigned one particular channel. Rather, several users could share one or more internet channels with secure IP address schemes.

### BRIEF DESCRIPTION OF THE SEVERAL VIEWS OF THE DRAWING

These and other features, aspects and advantages of the present invention are better understood with reference to the following description, appended claims and drawings where:

FIG. 1 is a diagram of the different components of a UINPOP system according to the present invention;

FIG. 2 is a simplified diagram of the system with respect to a single dial-up subscriber according to the present invention;

FIG. 3 is a simplified diagram of the network connectivity according to the present invention;

FIG. 4 is a simplified diagram of the signal routing interface according to the present invention;

FIG. 5 is a simplified diagram of the wireless interface according to the present invention;

FIG. 6 is a simplified diagram of the auxiliary system components according to the present invention;

### DETAILED DESCRIPTION OF THE INVENTION

The following is a brief description of the wired internet loop (WIL) system of the present invention. The combination of designated components and the process in which they are used is unique to the industry. The numerical examples provided are provided as examples and are not meant to limit the scope of the invention.

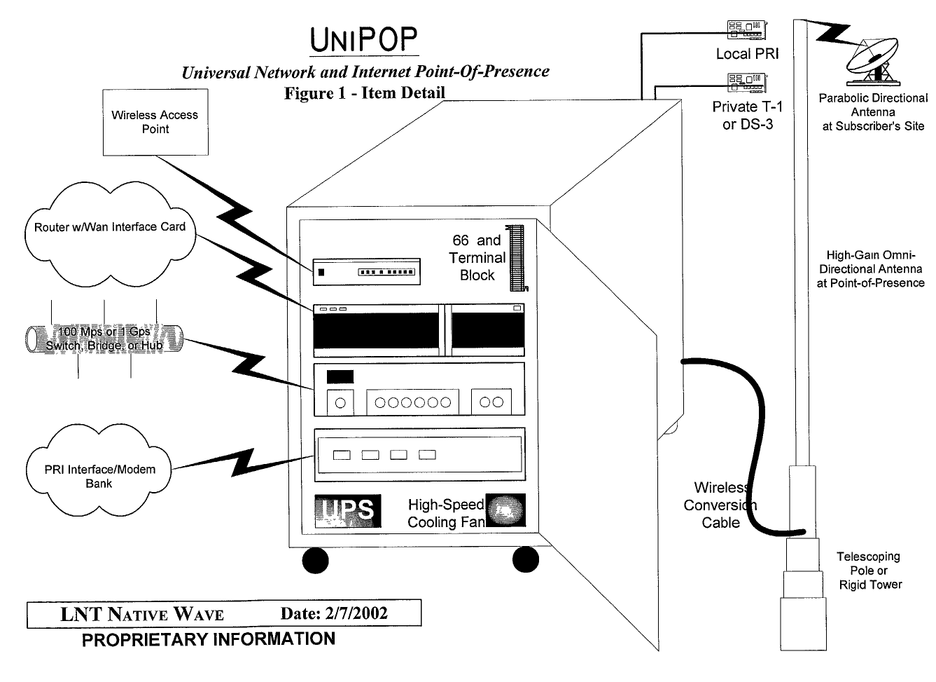

FIG. 1 shows the different components of the WIL system. The WIL system connects to the copper wire local T-1 or DS-3 loop of a typical telephone system. In FIG. 1, the WIL is essentially configured with an incoming 23-channel PRI interface(s) connected to an internet T-1 (1.544 mps) or DS-3 (45 mps). The various other items thus constitute the WIL system.

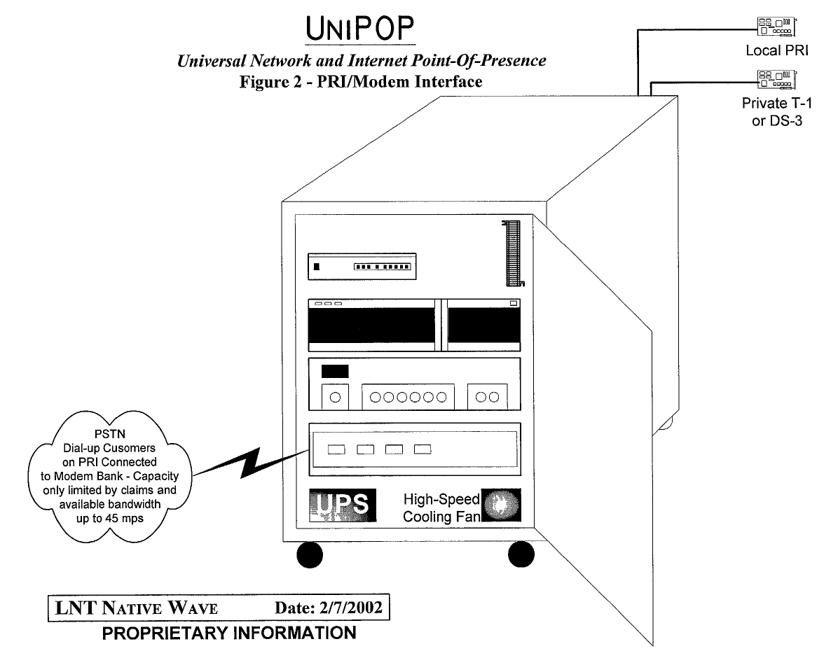

FIG. 2 shows a simplified diagram of an analog to digital interface with respect to a single dial-up user. By allowing for various individual users that communicate with a single modular point-of-presence, the WIL thus provides point-to-point wired communications at up to 56 kilobits per second.

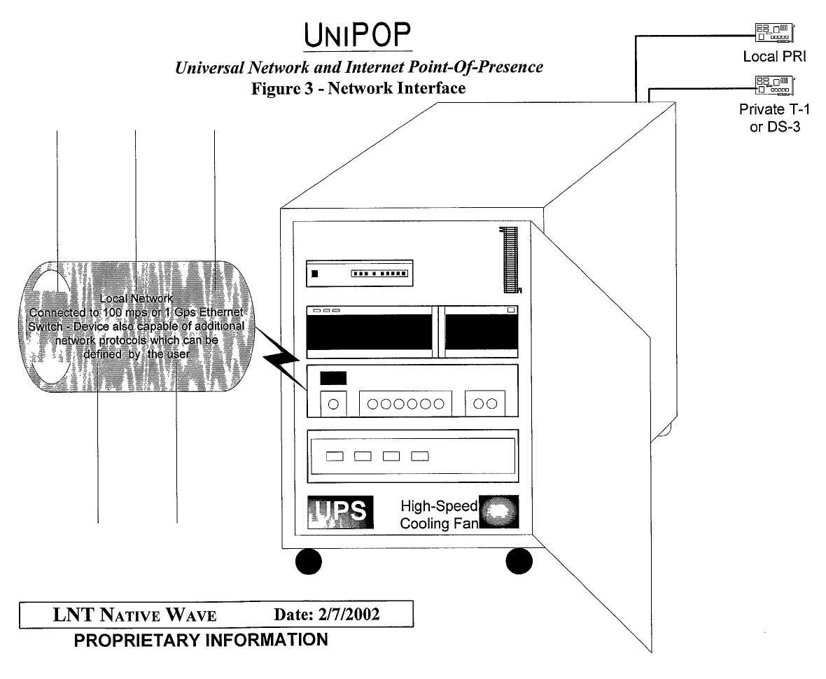

FIG. 3 shows a simplified diagram of the network connectivity with respect to the local network connections to the UNIPOP. The system allows for data throughput scalability up to 1 gigabit per second (gps) and multiple connections based on customer requirements.

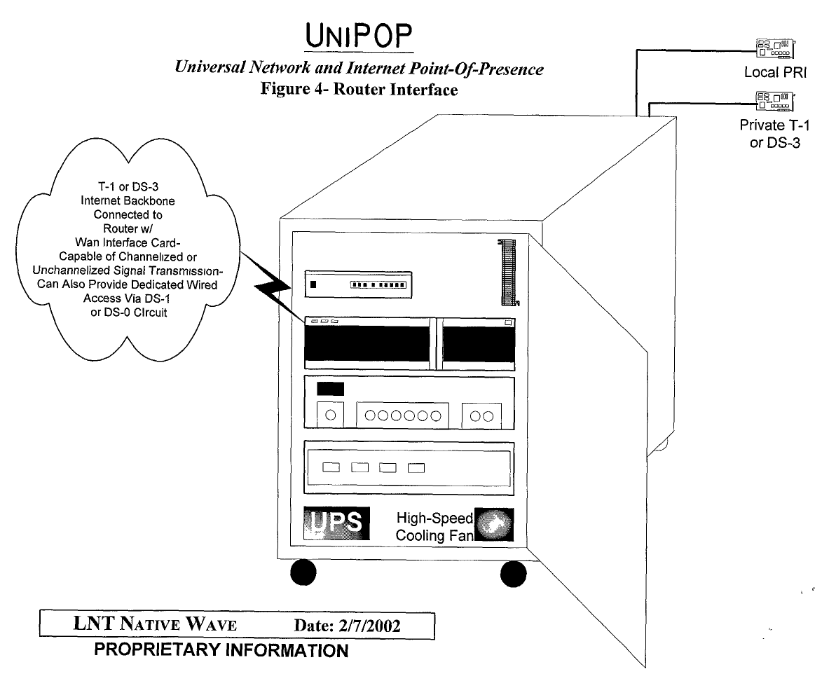

FIG. 4 shows a simplified diagram of the signal routing interface. This interface is scalable up to 1 gps and provides for the routing of multiple network protocols and data forms.

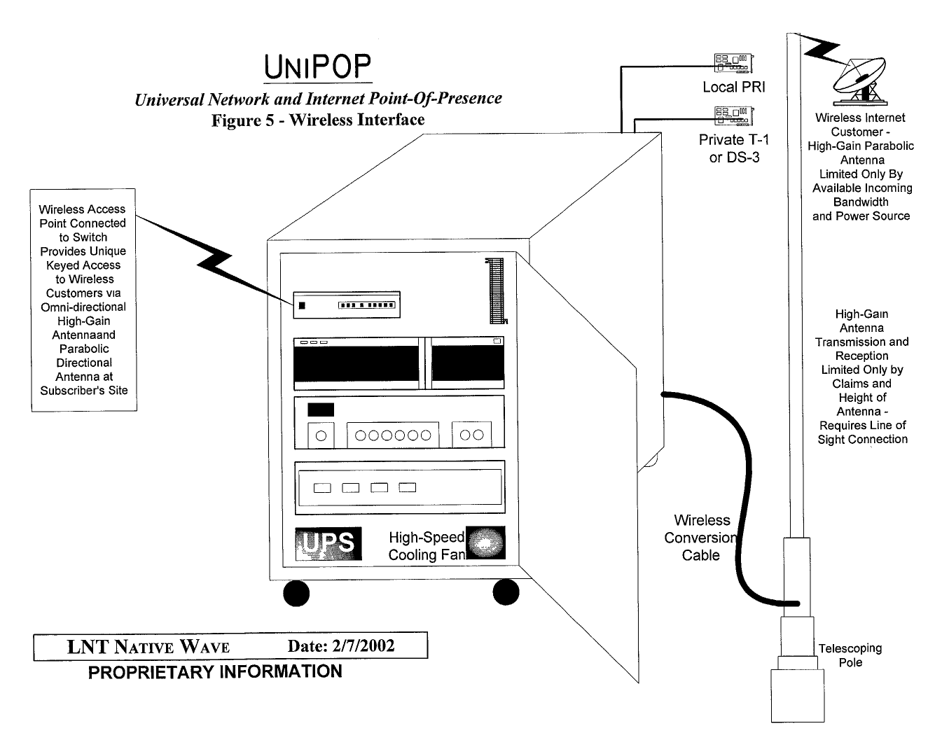

FIG. 5 shows a simplified diagram of the wireless interface according to the present invention. This interface provides for the integration of Gigahertz signaling transmission and reception through the use of omni-directional and parabolic antennae.

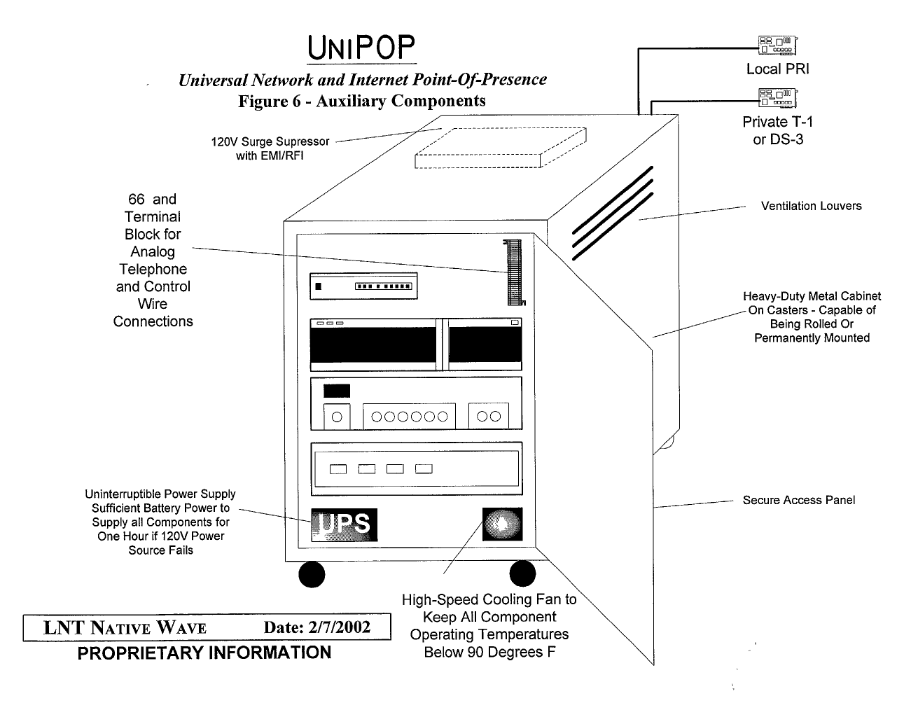

FIG. 6 is a simplified diagram of the auxiliary system components used in the UNIPOP. These components supply functions necessary to deploy the UNIPOP successfully and maintain operation.

The customer premise interface must be equipped with a analog data port, dedicated T-1 or 56 kps interface, or a wireless access point. The UNIPOP is capable of processing and routing data through a telecommunications network; the UNIPOP provides an internet service connection that assigns the user with an IP address which the present invention associates with a virtual IP address. With these provisions met, the LAN implements internet protocols to established internet service.

A connection is initiated by the subscriber. Note that if a customer is using a business server at the customer premise interface, both the server and the customer premise interface will be active at all times. Once the service request is initiated, the internet channel is used for access request as in a similar voice service for the dial-up connection. The UNIPOP then provides an access grant where a IP address is provided. The subscriber then acknowledges the UNIPOP's access grant. Upon a failure the sequence is repeated until successful completion or timeout.

In the wireless LAN, service association and authentication protocols are implemented as follows. The UNIPOP requests a packet. The subscriber station replies with an IP and subscriber station key. This step is repeated until successful or a timeout is reached. The UNIPOP then authenticates the IP and/or subscriber station key against a provision table previously established. Upon successful authentication, the UNIPOP grants access. Alternatively, if the user is not provisioned properly, the UNIPOP denies access.

Under normal operations the UNIPOP transmits outbound packets and control information and the subscriber station replies in a token ring manner. The subscriber station transmits fragmented information as detailed previously in this specification. Retransmission of TCP/IP data is as required in the TCP/IP protocol.

In order to improve efficient use of resources it may be necessary to implement timeout and disconnect procedures where the user is disconnected after no data is transmitted for a specified amount of time. With such an occurrence a message is sent so as to reset the stations. Upon further need for data access, the user's service is re-established.

The UNIPOP is designed to meet the unique needs of the small to mid-size area with universal wired and wireless requirements. The wireless gigahertz spectrum that the present invention uses is a valuable and untapped resource. It is our contention that this system and process will provide a much-needed resource to any rural community and also provide the means for efficient and cost-effective internet communications in any localized environment.

It should be appreciated by those skilled in the art that the specific embodiments disclosed above may be readily utilized as a basis for modifying or designing other UNIPOP systems for carrying out the same purposes of the present invention. Similarly some information may be changed to meet certain specialized needs. It should also be appreciated by those skilled in the art that equivalent systems and assemblies do not depart from the spirit and scope of the invention as set forth in the appended claims.

What is claimed is:

1. A wired telecommunication system to allow individual subscribers in an area of service telecommunications access to a telecommunications network comprising:
at least one subscriber interface,
at least one subscriber interface connected to one or more items of customer premise equipment,
the customer premise equipment capable of transmitting and/or receiving data signals;
at least one subscriber interface having a modulator for modulating voice and/or data signals from the customer premise equipment into a form suitable for transmission over a wired communication channel;
at least one subscriber interface having a demodulator for demodulating a signal received over a wired communication channel into a data signal;
a modular point-of-presence interface,
the modular point-of-presence interface connecting the telecommunication network to the wired telecommunication system;
the modular point-of-presence interface having a modulator for modulating voice and/or data information from the telecommunication network into a form suitable for transmission over a wired communication channel;
the modular point-of-presence interface having a demodulator for demodulating a signal received over a wired communication channel into a form suitable for transmission over the telecommunication network.

2. The system of claim 1, wherein the integral devices combine to uniquely provide dial-up and dedicated wired internet connections of bandwidths from DS-0 (64 kilobits per second “kps” or one channel) to DS-3 (45 megabits per second “mps” or 672 channels).

3. The system of claim 1, wherein the customer-premise equipment may also provide multi-protocol routing/switching and bridging.

4. The system of claim 1, wherein the number of channels assigned to a subscriber station can be changed dynamically depending on the channel usage and/or subscription rate.

5. The system of claim 1, wherein the subscriber interface universally services a customer unit.

6. A wireless telecommunication system to allow individual subscribers in an area of service telecommunications access to a telecommunications network comprising:
at least one subscriber interface,
at least one subscriber interface connected to one or more items of customer premise equipment,
the customer premise equipment capable of transmitting and/or receiving data signals up to 11 mps throughput;
at least one subscriber interface having a modulator for modulating voice and/or data signals from the customer premises equipment into a form suitable for transmission over a wireless communication channel;
at least one subscriber interface having a demodulator for demodulating a signal received over a wireless communication channel into a voice or data signal;
a modular point-of-presence interface,
the modular point-of-presence interface connecting the wireless telecommunication system to the telecommunication network;
the modular point-of-presence interface having a modulator for modulating voice and/or data information from the telecommunication network into a form suitable for transmission over a wireless communication channel;
the modular point-of-presence interface having a demodulator for demodulating a signal received over a wireless communication channel into a form suitable for transmission over the telecommunication network;
a plurality of wireless communication channels being used for communication between the modular point-of-presence interface and the plurality of subscriber interfaces.
